(19) United States
(12) Patent Application Publication
(10) Pub. No.: US 2010/0184489 A1
(43) Pub. Date: Jul. 22, 2010

(54) METHOD AND APPARATUS FOR REDUCING POWER CONSUMPTION IN A WIRELESS DEVICE

(75) Inventors: Bertrand Penther, Rue De La Marne (FR); Francois Babin, Cugnaux (FR)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: MOTOROLA INC., Tempe, AZ (US)

(21) Appl. No.: 12/354,954

(22) Filed: Jan. 16, 2009

(51) Int. Cl. H04B 1/38

(52) U.S. Cl. 455/574

(57) ABSTRACT

A method and apparatus are provided for reducing power consumption within a wireless device operating on a downlink shared control channel. The method includes the steps of monitoring the downlink shared control channel for control messages, detecting an access grant from a cyclic redundancy check process, decoding the detected access grant and determining a type of access grant from the decoded access grant and activating a portion of the wireless device in response to the determined type of access grant.

### FIELD OF THE INVENTION

The field of the invention relates to wireless devices and more particularly to methods and apparatus for reducing the power consumption of wireless devices.

### BACKGROUND OF THE INVENTION

Wireless devices are generally known. Such devices may be used to exchange voice or data with other wireless devices or with remotely located servers. For example, the wireless device may be a cellular telephone that may allow access to other cellular phone users or to tethered users through the public switch telephone network.

Alternatively, the wireless device may be a portable data assistant (PDA). In the case of a PDA, the wireless device may be used to access e-mail accounts or websites through the Internet.

Due to advances in technology and lower prices, the demand for wireless devices has grown exponentially. In order to handle the increased volume, wireless carriers have implemented a number of changes to the air interface. For example, rather than dedicating a frequency to a single user for the duration of a call, recent improvements have included the usage of time division multiplexing (e.g., GSM devices) or code division multiplexing (e.g., 3G devices).

One of the difficulties with conventional air interfaces is that wireless data devices have vastly differently data requirements among devices and even for a particular data device during the course of a particular session. In order to address this challenge, some types of Evolved 3GPP devices such as Long Term Evolution (LTE) devices incorporate the concept of variable bandwidth into the channel allocation format.

While the use of variable bandwidth is effective in accommodating the viability of data transfer, the higher throughput of LTE requires the use of faster and more complex data processors or hardware logic. While the use of faster and more complex processors or hardware logic is effective in handling the greater data requirements, they also consume more power. Because of the importance of wireless devices, a need exists for better methods of controlling power consumption within such devices.

### SUMMARY OF THE INVENTION

A method and apparatus are provided for reducing power consumption within a wireless device operating on a downlink shared control channel. The method includes the steps of monitoring the downlink shared control channel for control messages, detecting an access grant from a cyclic redundancy check process, decoding the detected access grant and determining a type of access grant from the decoded access grant and activating a portion of the wireless device in response to the determined type of access grant.

In another aspect, an apparatus for reducing power consumption within a wireless device operating on an orthogonal frequency division multiple access channel. The apparatus includes a receiver monitoring the orthogonal frequency division multiple access channel for control messages, a cyclic redundancy processor detecting an access grant, decoding the detected access grant and determining a type of access grant from the decoded access grant and a power and clock energy manager processor activating a portion of the wireless device in response to the determined type of access grant.

In another aspect, an apparatus for reducing power consumption within a wireless device operating on an orthogonal frequency division multiple access channel. The apparatus includes means for monitoring the orthogonal frequency division multiple access channel for control messages, means for detecting an access grant from a cyclic redundancy check process, means for decoding the detected access grant, means for determining a type of access grant from the decoded access grant and means for activating a portion of the wireless device in response to the determined type of access grant.

### BRIEF DESCRIPTION OF THE DRAWINGS

FIG. 1 is a block diagram of a wireless communication system in accordance with an illustrated embodiment of the invention;

FIG. 2 is a block diagram of a terminal used within the system of FIG. 1; and

FIG. 3 is a timing diagram that may be used by the terminal of FIG. 2.

### DETAILED DESCRIPTION OF AN ILLUSTRATED EMBODIMENT

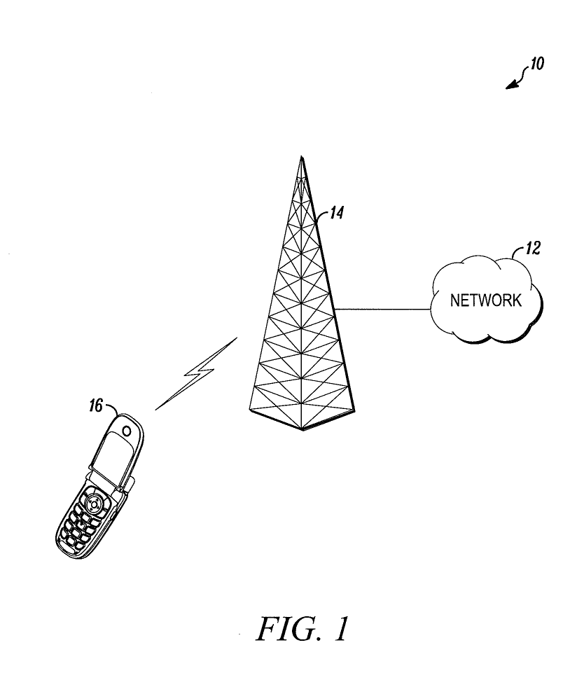

FIG. 1 is a block diagram of a wireless communication system 10 shown generally in accordance with an illustrated embodiment of the invention. The system 10 may operate under an Evolved 3GPP Long Term Evolution (LTE) format.

The network 12 may operate to provide any of a number of different types of functionality. For example, the network 12 may be a data network, a telecommunication network or a combination of data and telecommunication networks. The system 10 downlink may also operate under an orthogonal frequency division multiplexed (OFDM) format within a 20 MHz or smaller operating spectrum.

Included within the system 10 may be a wireless network 12, a base station 14 and a terminal 16. The terminal 16 is a wireless device (e.g., a wireless telephone, cellular telephone, personal digital assistant, a pager, a personal computer, a selective call receiver) capable of exchanging communication signals with the network 12. The terminal 16 may request access and be assigned to operate (downlink transmissions) under an OFDM format on at least some of the N subspectrums of the operating spectrum under control of the base station 14.

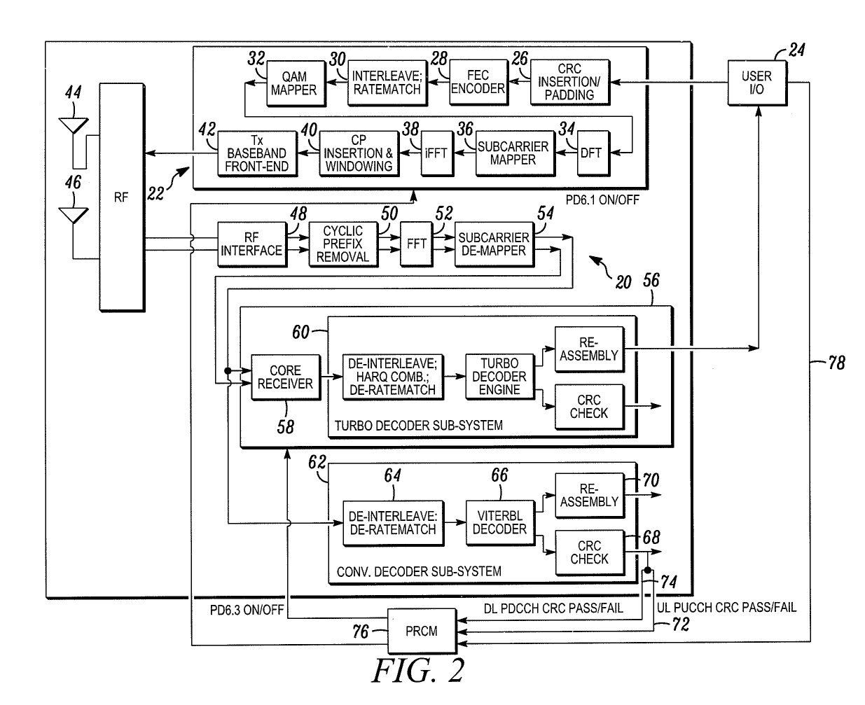

FIG. 2 is a simplified block diagram of a transmitter 20 and receiver 22 of the terminal 16. In order to place a call, send a message or retrieve information, a user (not shown) may activate the terminal 16 and enter a target identifier (e.g., a telephone number, URL, URI, etc.) through a user I/O device (e.g., a keyboard) 24 and activate a SEND button on the I/O device 24 of the terminal 16. In response, the terminal 16 may compose an access request packet (PRACH) for transmission to the base station 14. In a first step in transmitting the PRACH packet, the terminal may search for system information broadcasted by the network in the cell to get an adequate set of parameters to build a PRACH signal with the appropriate time/frequency limitations. Included within the PRACH may be an identifier of the type of access desired as well as an electronic serial number of the terminal.

In response to PRACH request, the base station 14 may transmit an access grant mapped on downlink shared control channel (PDCCH) to the terminal 16 under the OFDM format identifying a subframe and spectrum of a channel for transmission of information to the base station 14. If the access grant is for a physical uplink shared channel (PUSCH) transmission, the processing of uplink data stream may occur as follows. First, a cyclic redundancy check number may be calculated from an uplink input bit stream within the CRC insertion/padding processor 26 for insertion within the PUSCH packet. The bit stream may be encoded using any of a number of different coding format (e.g., tail biting convolutional coding, turbo coding, etc.) into a set of parallel bit streams within a FEC encoder 28. A set of parallel bits streams from the FEC encoder 28 may be interleaved within an Interleave; Rate Match processor 30. Following interleaving, the bits may be mapped into a QAM constellation within a QAM mapping processor 32.

In anticipation of mapping into the subspectrums of the operating spectrum and to generate a Single Carrier-Frequency Division Multiplexing Access (SC-FDMA) signal, the uplink packet may be Fourier transformed within a DFT processor 34 and then mapped into the identified N subspectrums within a subcarrier mapping processor 36. The mapped values may be converted back to the time domain within an iFFT processor 38. Following conversion, a cyclic prefix may be inserted into the packet and the packet may be windowed within the CP Insertion and Windowing processor 40. Once windowed, the SC-FDMA packet may be frequency translated within a Tx Baseband Front-End processor 42 before transmission to the base station 14 through one or more antenna 44, 46.

Packets received from the base station 14 may be processed in a similar manner except that the physical downlink shared channel (PDSCH) operates under a multichannel OFDM. In this regard, a RF interface processor 48 may reduce a received signal to baseband. A Cyclic Prefix Removal processor 50 may recover the cyclic prefix. A fast Fourier transform processor 50 may recover the specific spectral components of the signal whereas a Subcarrier De-mapper processor 54 may recover the specific bits based upon location within the encoding constellation.

A decoding receiver 56 may be used to recover user information. In this regard, a multiple input multiple output (MIMO) process may be used within a core receiver 58 to recover space-time coded signals from both antennas 44, 46. A turbo decoder subsystem 60 may be used to complete the recovery of user information.

Also associated with the receiver 20 may be a convolutional decoder subsystem 62 for recovering PDCCH control information from the base station 14. A De-Interleaver and de-RateMatic processor 64 may be used to deinterleave the streams of information and a Viterbi Decoder processor 66 may be used to estimate the encoded control information from the base station 14. Decoded information may be divided into terminal control information intended for control of the terminal 16 (recovered by a reassembly processor 70) and CRC information recovered by a CRC processor 68.

It should be noted in this regard that the CRC processor 68 provides a positive (true) output whenever channel grants intended for (and addressed to) the terminal 16 are received. In this regard, the CRC processor 68 provides a pass/fail output 74 whenever a downlink channel grant is received on the DL-PDCCH from the base station 14. The CRC processor 68 also provides a pass/fail output 72 when ever an uplink channel grant is received from the CRC processor 68.

Associated with the CRC processor 68 is a power and clock energy manager module (PRCM) 76 that functions to activate the transmitter 22 and portions of the receiver 20 upon detection of a channel grant. The PRCM 76 may also be activated by a signal 78 from the user I/O 24 based upon case specific scheduling patterns (e.g., persistent scheduling, VoIP active/idle, etc.).

In general, the terminal 16 interprets the resource allocation field of the PDCCH depending upon the PDCCH format detected. For example, the terminal 16 may operate in accordance with specification number 3GPP TS 36.212 or 3GPP TS 36.213, both available from the 3^{rd} Generation Partnership Project; Technical Specification Group Radio Access Network; Evolved Universal Terrestrial Radio Access (E-UTRA); Multiplexing and Channel Coding and both incorporated herein by reference.

For example, a resource allocation field within each PDCCH message includes two parts: 1) a resource allocation header field and 2) information consisting of the actual resource block assignment. PDCCH downlink control information (DCI) formats 1, 2 and 2A with type 0 and PDCCH DCI formats 1, 2 and 2A with type 1 resource allocation have the same format and are distinguished from each other via the single bit resource allocation header field which exists depending on the downlink system bandwidth, where type 0 is indicated by 0 value and type 1 is indicated otherwise. PDCCH with DCI format 1A, 1B and 1C have a type 2 resource allocation while PDCCH with DCI format 1, 2 and 2A have type 0 or type 1 resource allocation. PDCCH DCI formats with a type 2 resource allocation do not have a resource allocation header field.

For downlink, to determine the modulation order and transport block size(s) in the PDSCH, the terminal 16, first, reads the 5-bit modulation and coding scheme (MCS) field (I_{mcs}) in the DCI and, second, if the DCI CRC is scrambled by paging radio network temporary identifier (P-RNTI), the random access radio network temporary identifier (RA-RNTI) or system information radio network temporary identifier (SI-RNTI), then for DCI 1A or DCI 1C, then the terminal 16 sets the transport block size to a predetermined respective value. Otherwise, the physical resource block (PRB) size is set as discussed above.

The terminal 16 may skip decoding a transport block in an initial transmission if the effective channel code rate is higher than 0.930, where the effective channel code rate is defined as the number of downlink information bits (including CRC bits) divided by the number of physical channel bits on the PDSCH. If the terminal 16 skips decoding, the terminal 16 sends a negative acknowledgement (NAK).

For an uplink access grant, the terminal 16 may take other steps. For example, to determine the modulation order, redundancy version and transport block size for the PUSCH, the terminal 16 will, first, read the 5-bit MCS and redundancy version field (I_{mcs}) in the DCI, check the channel quality indicator (CQI) bit in the DCI and compute the total number of allocated PRB (N_{PRB}) using a predetermined procedure defined for LTE and compute the number of coded symbols for control information, again, using the procedure defined for LTE.

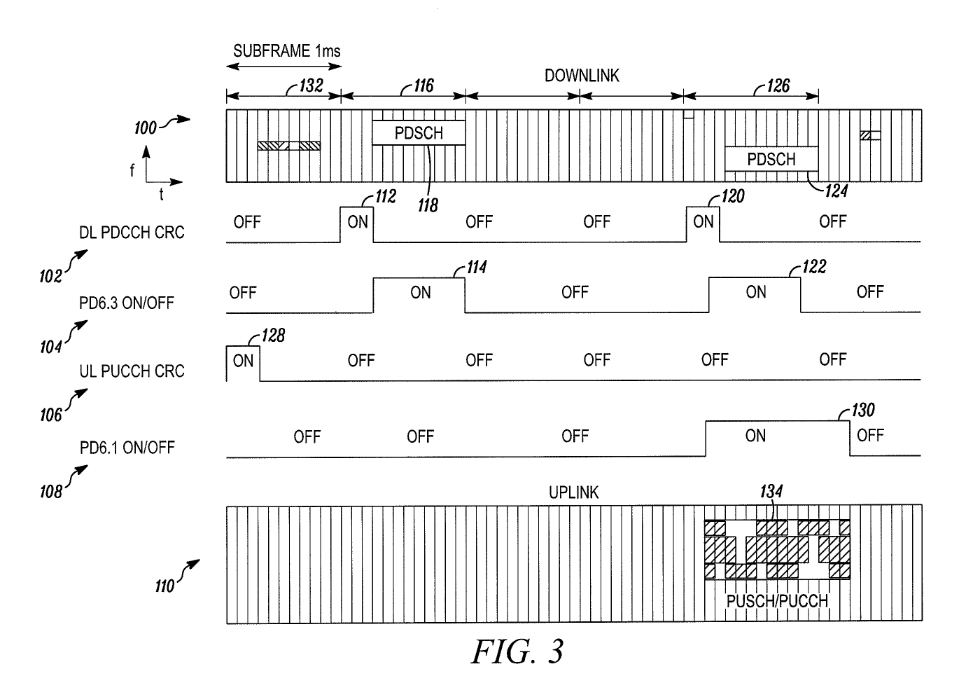

FIG. 3 depicts an example of the operation of the PRCM 76 under an illustrated embodiment of the invention. Shown in FIG. 3 is a multiframe portion 100 of an OFDM transmission frame where the vertical direction indicates increasing frequency and the horizontal direction indicates increasing time. As shown, each subframe may be 1 ms long and include 14 symbol transmission periods each beginning with 3 control symbol periods (the number of control symbol periods could be 1, 2 or 3).

Shown below and vertically aligned with the portion 100 is a time chart 102 of an output signal on the DL PDCCH CRC 74. Shown below the time chart 102 is a time chart 104 that shows activation of the core receiver 58 and turbo decoder 60 by the PRCM 76. As shown, upon detection of a CRC output signal 112, the PRCM 76 activates 114 the core receiver 58 and turbo decoder 60 within the same 1 ms long subframe 116 to decode the packet 118.

As also shown in FIG. 3, a second access grant 120 is received in the fourth subframe 126. As above, receipt of the access grant 120 in the fourth subframe 126 results in activation of the core receiver 58 and turbo decoder 60 and decoding of a second packet 124 within the fourth subframe. The difference in vertical direction between the first packet 118 and second packet 124 indicates assignment of a different set of OFDM subchannels for receipt of the second packet 124.

Also shown in FIG. 3 is a timing diagram 106 of the output 72 of the CRC processor 68 indicating a grant of an uplink channel. In this case, the access grant 128 is received during a first subframe 132 and the PRCM 76 activates the transmitter 22 during the fourth subframe 126. In this case, the 4 ms delay is provided to allow the transmitter 20 additional time to process data before transmission occurs.

As indicated above, the PRCM 76 may also activate the transmitter 22 based upon control signals 78 from the user I/O 24. Signals 78 that may activate the PRCM 76 may include activation of the SEND button in cases of placing a call or activation of an ACCESS button for accessing e-mail or the Internet. In the case of VoIP, the activation signal 78 may be based upon the status of an audio buffer or upon some maximum time between transmissions.

The PRCM 76 may activate the transmitter 22 or receiver 20 for some predetermined time period determined from information contained within the access grant. Alternatively, the PRCM 76 may maintain the transmitter 22 or receiver 20 active only until the end of a current subframe which in the case of the downlink would only be 1 ms or in the case of an uplink for 4 ms after receipt of an access grant. The link between access grant detection 74 or 72 and PRCM 76 can be fully hardware or hard wired, without software involvement (except for initial configuration). In the same way, the link between the PRCM 76 and core receiver 58/turbo-decoder 60 or transmitter 22 for activation can be fully implemented in hardware or hard wired, without software involvement (except for initial configuration).

While the PRCM 76 may operate by activating the transmitter 22 or receiver 20, the PRCM 76 may also adjust a voltage and/or frequency of a clock signal to the processors or hardware logic within the transmitter 22 or receiver 20. Reducing the frequency allows the processors or hardware logic to operate at a slower speed thereby consuming less battery power. Similarly, reducing the operating voltage has a similar effect.

In general, deactivating the transmitter 20 and receiver 20 (or reducing the voltage and clock frequency) reduces battery drain within the terminal 16. Reducing battery drain has the beneficial effect of increasing an operating time of the terminal 16 between recharging.

A specific embodiment of method and apparatus for reducing power drain has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method for reducing power consumption within a wireless device operating on a downlink shared control channel, such method comprising:
monitoring the downlink shared control channel for control messages;
detecting an access grant from a cyclic redundancy check process;
decoding the detected access grant;
determining a type of access grant from the decoded access grant; and
activating a portion of the wireless device in response to the determined type of access grant.

2. The method for reducing power consumption as in claim 1 wherein the shared control channel further comprises an orthogonal frequency division multiple access channel and monitoring the control messages further comprises extracting control information from the time/frequency domain.

3. The method of reducing power consumption as in claim 1 wherein the activated portion further comprises a receiver.

4. The method of reducing power consumption as in claim 3 wherein the activated portion further comprises a turbo decoder portion of the receiver.

5. The method of reducing power consumption as in claim 3 further comprising detecting the access grant on a first subframe of the orthogonal frequency division multiple access channel and activating the receiver within the same first subframe.

6. The method of reducing power consumption as in claim 1 wherein the activated portion further comprises a transmitter.

7. The method of reducing power consumption as in claim 6 further comprising detecting the access grant on a first subframe of the orthogonal frequency division multiple access channel and activating the receiver on a fourth subframe first following the first subframe

8. The method of reducing power consumption as in claim 1 wherein the access grant further comprises a bandwidth.

9. The method of reducing power consumption as in claim 8 wherein the bandwidth of the grant further comprises a set of resource block groups.

10. The method of reducing power consumption as in claim 8 wherein the resource block groups further comprise a set of consecutive physical resource blocks.

11. The method of reducing power consumption as in claim 1 wherein the activation of the portion further comprises changing a potential and/or frequency of a processor or hardware logic of the portion.

12. The method of reducing power consumption as in claim 1 wherein the activated portion of the transmitter and receiver are split in groups of hardware logic belonging to the same island of power/voltage supply.

13. The method of reducing power consumption as in claim 1 wherein the deactivation of the portion further comprises clock gating of a group of logic, putting in retention voltage a power domain, power/voltage gating a power/voltage domain.

14. An apparatus for reducing power consumption within a wireless device operating on an orthogonal frequency division multiple access channel, such apparatus comprising:
a receiver monitoring the orthogonal frequency division multiple access channel for control messages;
a cyclic redundancy processor detecting an access grant, decoding the detected access grant and determining a type of access grant from the decoded access grant; and
a power and clock energy manager processor activating a portion of the wireless device in response to the determined type of access grant.

15. The apparatus for reducing power consumption as in claim 14 wherein the activated portion further comprises a receiver.

16. The apparatus for reducing power consumption as in claim 15 wherein the activated portion further comprises a turbo decoder portion of the receiver.

17. The apparatus for reducing power consumption as in claim 15 further comprising detecting the access grant on a first subframe of the orthogonal frequency division multiple access channel and activating the receiver within the same first subframe.

18. The apparatus for reducing power consumption as in claim 14 wherein the activated portion further comprises a transmitter.

19. The apparatus for reducing power consumption as in claim 18 further comprising detecting the access grant on a first subframe of the orthogonal frequency division multiple access channel and activating the receiver on a fourth subframe first following the first subframe

20. The apparatus for reducing power consumption as in claim 14 wherein the access grant further comprises a bandwidth.

21. An apparatus for reducing power consumption within a wireless device operating on an orthogonal frequency division multiple access channel, such apparatus comprising:
means for monitoring the orthogonal frequency division multiple access channel for control messages;
means for detecting an access grant from a cyclic redundancy check process;
means for decoding the detected access grant;
means for determining a type of access grant from the decoded access grant; and
means for activating a portion of the wireless device in response to the determined type of access grant.

22. An apparatus for activating a portion of the wireless as in claim 21 wherein the link between the detection of access grant, identification of access grant and activation of a portion of the wireless device is fully implemented in hardware or is hard wired, without software involvement except for initial configuration.

23. An apparatus for activating a portion of the wireless as in claim 21 wherein the mechanism between the detection of access grant, identification of access grant and activation of a portion of the wireless device further comprises a power and clock energy manager module that receives detection and identification of access grant via hardware lines, without software involvement except for initial configuration of the said power and clock energy manager module.

24. An apparatus for activating a portion of the wireless as in claim 21 wherein the mechanism between the detection of access grant, identification of access grant and activation of a portion of the wireless device further comprises a power and clock energy manager module that activates a portion of the wireless device via hardware lines commands, without software involvement except for initial configuration of the said power and clock energy manager module.
